(19) United States
(12) Patent Application Publication
(10) Pub. No.: US 2019/0323582 A1
(43) Pub. Date: Oct. 24, 2019

(54) IDLER ASSEMBLY FOR A BALL VARIATOR CONTINUOUSLY VARIABLE TRANSMISSION

(71) Applicant: Dana Limited, Maumee, OH (US)

(72) Inventors: Joseph J. Horak, Austin, TX (US); Gordon M. McIndoe, Volente, TX (US); Matthew Simister, Austin, TX (US)

(21) Appl. No.: 16/182,920

(22) Filed: Nov. 7, 2018

Related U.S. Application Data
(60) Provisional application No. 62/661,814, filed on Apr. 24, 2018.

(51) Int. Cl. F16H 15/50; F16H 15/52

(52) U.S. Cl. CPC F16H 15/503; F16H 15/52

(57) ABSTRACT

Provided herein is a continuously variable planetary (CVP) having a plurality of balls, each ball having a tiltable axis of rotation, each ball in contact with a first traction ring and a second traction ring, the CVP including a carrier assembly supporting each ball, the carrier assembly comprising a first carrier member and a second carrier member; an idler located radially inward of, and in contact with, each ball; and a first axial positioning mechanism coupled to the idler and the first carrier member, wherein the first axial positioning mechanism adjusts the axial position of the idler during operation.

### RELATED APPLICATION

This application claims priority to and the benefit of U.S. Provisional Patent Application No. 62/661,814 filed on Apr. 24, 2018 which is incorporated by reference herein.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY

Provided herein is a continuously variable planetary (CVP) having a plurality of balls, each ball having a tiltable axis of rotation, each ball in contact with a first traction ring and a second traction ring, the CVP including: a carrier assembly supporting each ball, the carrier assembly having a first carrier member and a second carrier member; an idler located radially inward of, and in contact with, each ball; a first axial positioning mechanism coupled to the idler and the first carrier member; and wherein the first axial positioning mechanism adjusts the axial position of the idler during operation.

In some embodiments of the CVP, the first axial positioning mechanism further includes an axial thrust bearing coupled to the idler, a piston coupled to the axial thrust bearing, a cylinder coupled to the first carrier member, the cylinder configured to surround the piston, and a spring enclosed by the cylinder and in contact with the piston.

In some embodiments of the CVP, the first carrier member further includes a fluid passage arranged to provide fluid to the cylinder.

In some embodiments of the CVP, a valve is coupled to the piston, the valve has a valve orifice, and the valve is adapted to axially displace in unison with the piston to expose the valve orifice to the fluid passage.

In some embodiments of the CVP, a ball-and-cam type axial force generator is coupled to the idler and the second carrier member.

In some embodiments of the CVP, a second axial positioning mechanism is coupled to the idler and the second carrier member.

In some embodiments of the CVP, the second axial positioning mechanism further includes an axial thrust bearing coupled to the second carrier member, a piston coupled to the axial thrust bearing, a cylinder coupled to the idler, the cylinder is configured to surround the piston, and the cylinder has a fluid passage arranged on an outer periphery of the cylinder.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a ball-type variator provided with an idler assembly having an axial positioning mechanism.

FIG. 5 is a schematic diagram of the axial positioning mechanism of FIG. 4.

FIG. 6 is a schematic diagram of a ball-type variator provided with an idler assembly having another axial positioning mechanism.

FIG. 7 is a schematic diagram of a ball-type variator provided with an idler assembly having another axial positioning mechanism.

FIG. 8 is a schematic diagram of the axial positioning mechanism of FIG. 7.

FIG. 9 is a schematic diagram of a ball-type variator provided with an idler assembly having another axial positioning mechanism.

FIG. 10 is a schematic diagram of the axial positioning mechanism of FIG. 9.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

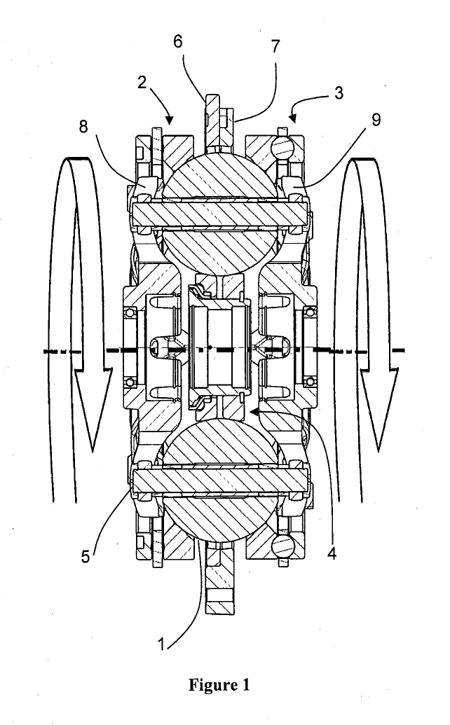

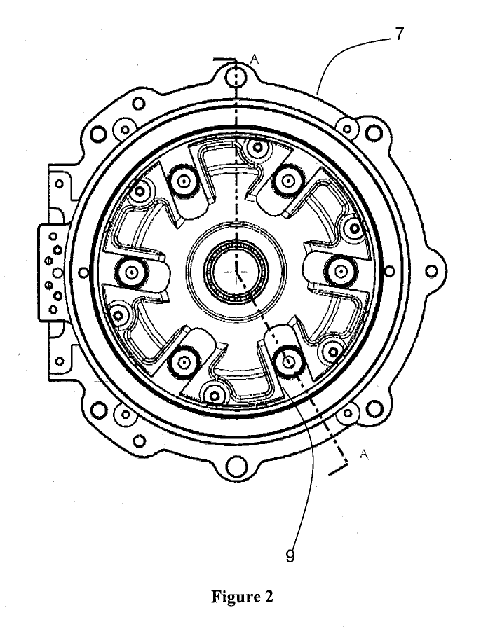

Provided herein are configurations of CVTs based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby causing a tilting of the balls' axes of rotation to adjust the speed ratio of the variator. Other types of ball CVTs also exist, but are slightly different.

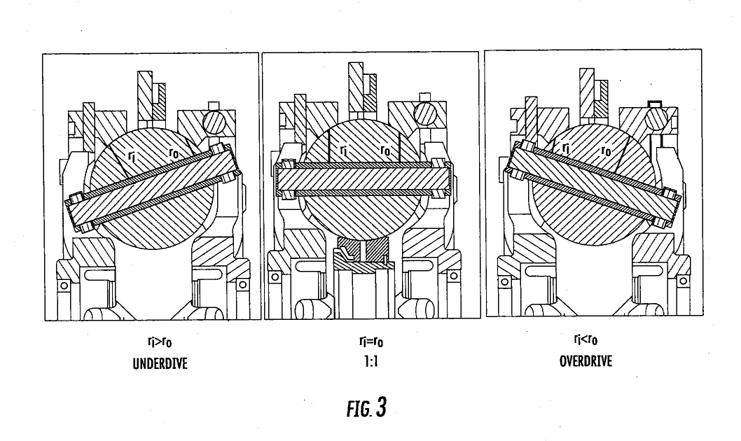

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one-to-one (1:1) illustrated in FIG. 3. When the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

Currently, CVT and Infinitely Variable Transmissions (IVT) often use some form of mechanical clamping mechanism, typically including a ball-and-cam mechanism to generate axial clamping forces necessary to facilitate the transmission of torque between or among transmission components via traction or friction, often referred to as clamping force mechanisms or generators. At high torques and low speeds, a standard ball-and-cam clamping force mechanism determines the clamp load. Examples of ball-and-cam clamping force mechanism are found in U.S. Pat. No. 9,086,145, which is hereby incorporated by reference.

Clamping force generators typically fall into three general categories: Non-Torque Reactive; Torque Reactive, and Active/Programmable. Non-Torque Reactive clamping means are generally defined as ratio dependent, speed dependent and fixed (fully preloaded). Torque Reactive clamping means are generally defined by axial forces due to: external influences or loads; torque reaction on floating elements; screws and cams; or passive hydraulic; and Active/Programmable clamping means wherein hydraulic or other means are actively applied to a clamping means to create axial clamping forces. Depending on the configuration used, the clamping force mechanism used in a transmission with a Continuously Variable Ball Planetary variator provides a load to the input and/or output ring to ensure adequate clamping force between the drive ring(s) and the traction planets.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally couₚled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in an embodiment where a CVT is used for a bicycle application, the CVT operates at times as a friction drive and at other times as a traction drive, depending on the torque and speed conditions present during operation.

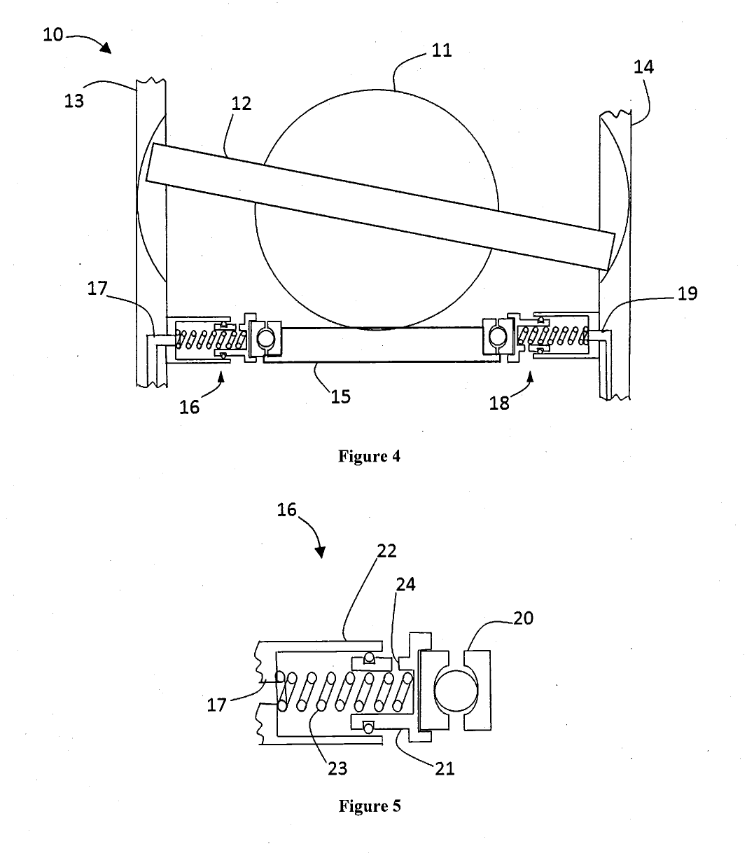

Referring now to FIGS. 4-7, in some embodiments, the idler assembly 4 depicted in FIG. 3 is optionally configured to respond to forces generated between traction components of the CVP.

In some embodiments, the forces generated during operation of the CVP moves the components of the idler assembly 4 axially to provide variation in location of the traction contacts between the idler assembly 4 and the balls 1.

In some embodiments, the movement of the components of the idler assembly 4 corresponds to a variation in flow of lubricant or traction fluid being supplied to the idler assembly 4.

In some embodiments, the response of the idler assembly 4 to forces generated during operation of the traction components are dampened by assemblies described herein.

Turning now to FIG. 4, in some embodiments, a ball-type variator, or continuously variable planetary (CVP) 10 is provided with a number of balls 11 supported on tiltable ball axles 12 in a first carrier member 13 and a second carrier member 14. The CVP 10 generally shares the same operating principles as the CVP described in FIGS. 1-3. For descriptions purposes, only the differences between the CVP 10 and the CVP depicted in FIGS. 1-3 will be described.

In some embodiments, the CVP 10 includes an idler 15 located radially inward of, and in contact with, each ball 11.

In some embodiments, the idler 15 is operably coupled to the first carrier member 13 with a first axial positioning mechanism 16.

In some embodiments, the first axial positioning mechanism 16 is supplied with a fluid through a fluid passage 17 formed in the first carrier member 13.

In some embodiments, the idler 15 is operably coupled to the second carrier member 14 with a second axial positioning mechanism 18.

In some embodiments, the second axial positioning mechanism 18 is supplied with a fluid through a fluid passage 19 formed in the second carrier member 14.

Referring now to FIG. 5, in some embodiments, the first axial positioning mechanism 16 is substantially similar to the second axial positioning mechanism 18. For description purposes, only the first axial positioning mechanism 16 will be described.

In some embodiments, the first axial positioning mechanism 16 includes an axial thrust bearing 20 arranged to couple to the idler 15. The axial thrust bearing 20 couples to a piston 21. The piston 21 is supported inside a cylinder 22 with a spring 23.

In some embodiments, the cylinder 22 is integral to the first carrier member 13 and is in fluid communication with the fluid passage 17.

In some embodiments, the fluid passage 47 is adapted to supply a fluid from a source to contacting surfaces of the CVP 40.

In some embodiments, the piston 21 is provided with an orifice 24.

During operation of the CVP 10, axial forces generated at the traction contact between the balls 11 and the idler 15 are reacted by the first axial positioning mechanism 16 and the second axial positioning mechanism 18 to thereby adjust the location of the traction contact on the surface of the idler 15.

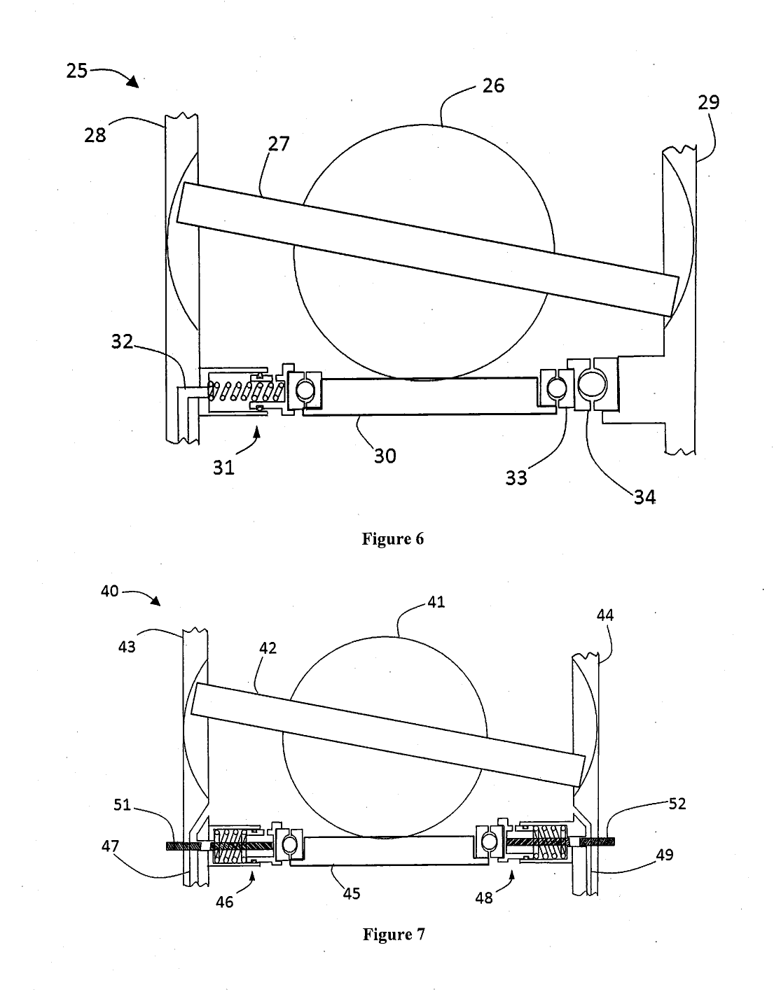

Referring now to FIG. 6, in some embodiments, a ball-type variator, or continuously variable planetary (CVP) 25 is provided with a number of balls 26 supported on tiltable ball axles 27 in a first carrier member 28 and a second carrier member 29. The CVP 25 generally shares the same operating principles as the CVP described in FIGS. 1-3. For descriptions purposes, only the differences between the CVP 25 and the CVP depicted in FIGS. 1-3 will be described.

In some embodiments, the CVP 25 includes an idler 30 located radially inward of, and in contact with, each ball 26. In some embodiments, the idler 30 is operably coupled to the first carrier member 28 with an axial positioning mechanism 31.

In some embodiments, the axial positioning mechanism 31 is supplied with a fluid through a fluid passage 32 formed in the first carrier member 28. In some embodiments, the axial positioning mechanism 31 provides damping to the idler 30.

In some embodiments, the idler 30 is operably coupled to the second carrier member 29 with an axial thrust bearing 33 and a ball-and-cam typed axial force generator 34. Examples of ball-and-cam clamping force mechanism are found in U.S. Pat. No. 9,086,145, which is hereby incorporated by reference.

During operation of the CVP 25, axial forces generated at the traction contact between the balls 26 and the idler 30 are reacted by the axial positioning mechanism 31 and the axial force generator 34 to thereby adjust the location of the traction contact on the surface of the idler 30.

Turning now to FIG. 7, in some embodiments, a ball-type variator, or continuously variable planetary (CVP) 40 is provided with a number of balls 41 supported on tiltable ball axles 42 in a first carrier member 43 and a second carrier member 44. The CVP 40 generally shares the same operating principles as the CVP described in FIGS. 1-3. For descriptions purposes, only the differences between the CVP 40 and the CVP depicted in FIGS. 1-3 will be described.

In some embodiments, the CVP 40 includes an idler 45 located radially inward of, and in contact with, each ball 41.

In some embodiments, the idler 45 is operably coupled to the first carrier member 43 with a first axial positioning mechanism 46.

In some embodiments, the first axial positioning mechanism 46 provides damping to the idler 45.

In some embodiments, the first axial positioning mechanism 46 is supplied with a fluid through a fluid passage 47 formed in the first carrier member 43. In some embodiments, the fluid passage 47 is adapted to supply a fluid from a source to contacting surfaces of the CVP 40.

In some embodiments, the idler 45 is operably coupled to the second carrier member 44 with a second axial positioning mechanism 48.

In some embodiments, the second axial positioning mechanism 48 is supplied with a fluid through a fluid passage 49 formed in the second carrier member 44. In some embodiments, the fluid passage 49 is adapted to supply a fluid from a source to contacting surfaces of the CVP 40.

In some embodiments, the first axial positioning mechanism 46 is provided with a first valve 51. The first valve 51 is adapted to control the flow of fluid through the fluid passage 47 in response to the idler 45.

In some embodiments, the second axial positioning mechanism 48 is provided with a second valve 52. The second valve 52 is adapted to control the flow of fluid through the fluid passage 49 in response to the idler 45.

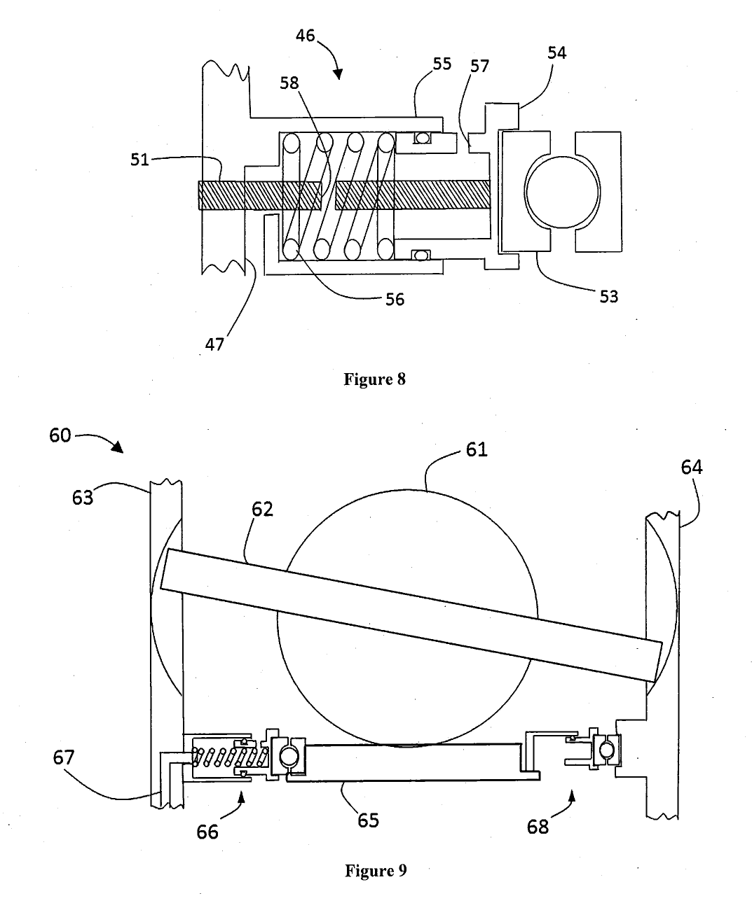

Referring now to FIG. 8, in some embodiments, the first axial positioning mechanism 46 is substantially similar to the second axial positioning mechanism 48. For description purposes, only the first axial positioning mechanism 46 will be described. In some embodiments, the first axial positioning mechanism 46 includes an axial thrust bearing 53 arranged to couple to the idler 45. The axial thrust bearing 53 couples to a piston 54. The piston 54 is supported inside a cylinder 55 with a spring 56.

In some embodiments, the cylinder 55 is integral to the first carrier member 43, and is in fluid communication with the fluid passage 47.

In some embodiments, the piston 54 is provided with an orifice 57.

In some embodiments, the first valve 51 is arranged coaxially with the piston 54 and the cylinder 55. The first valve 51 is attached to the piston 54, and therefore translates axially in unison with the piston 54.

During operation of the CVP 40, axial forces generated at the traction contact between the balls 41 and the idler 45 are reacted by the first axial positioning mechanism 46 and the second axial positioning mechanism 48 to thereby adjust the location of the traction contact on the surface of the idler 45.

Referring now to FIG. 9,in some embodiments, a ball-type variator, or continuously variable planetary (CVP) 60 is provided with a number of balls 61 supported on tiltable ball axles 62 in a first carrier member 63 and a second carrier member 64. The CVP 60 generally shares the same operating principles as the CVP described in FIGS. 1-3. For descriptions purposes, only the differences between the CVP 60 and the CVP depicted in FIGS. 1-3 will be described.

In some embodiments, the CVP 60 includes an idler 65 located radially inward of, and in contact with, each ball 61.

In some embodiments, the idler 65 is operably coupled to the first carrier member 63 with a first axial positioning mechanism 66.

In some embodiments, the first axial positioning mechanism 66 is supplied with a fluid through a fluid passage 67 formed in the first carrier member 63.

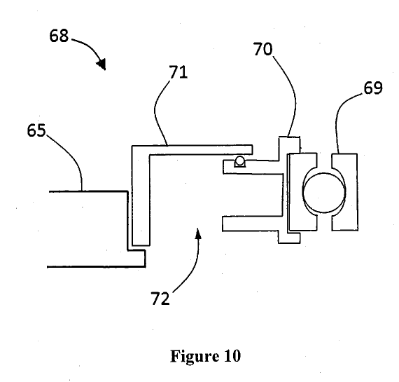

Referring now to FIG. 10, in some embodiments, the first axial positioning mechanism 66 is substantially similar to the first axial positioning mechanism 16.

In some embodiments, the second axial positioning mechanism 68 includes an axial thrust bearing 69 arranged to couple to the second carrier member 64. The axial thrust bearing 69 is coupled to a piston 70 supported by a cylinder 71.

In some embodiments, the cylinder 71 is coupled to the idler 65 and is configured to axially translate in unison with the idler 65.

In some embodiments, the cylinder 71 is provided with a fluid passage 72 formed along an outer periphery of the cylinder 71.

During operation of the CVP 60, axial forces generated at the traction contact between the balls 61 and the idler 65 are reacted by the first axial positioning mechanism 66 and the second axial positioning mechanism 68 to thereby adjust the location of the traction contact on the surface of the idler 65. The fluid passage 72 is configured to capture fluid during operation of the CVP 60. The captured fluid is subjected to centrifugal forces arid expands within the cylinder 71 to position the piston 70 axially.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable planetary having a plurality of balls, each ball having a tiltable axis of rotation, each ball in contact with a first traction ring and a second traction ring, the continuously variable planetary comprising:
a carrier assembly supporting each ball, the carrier assembly comprising a first carrier member and a second carrier member;
an idler located radially inward of, and in contact with, each ball; and
a first axial positioning mechanism coupled to the idler and the first carrier member,
wherein the first axial positioning mechanism adjusts the axial position of the idler during operation.

2. The continuously variable planetary of claim 1, wherein the first axial positioning mechanism further comprises an axial thrust bearing coupled to the idler, a piston coupled to the axial thrust bearing, a cylinder coupled to the first carrier member, the cylinder configured to surround the piston, and a spring enclosed by the cylinder and in contact with the piston.

3. The continuously variable planetary of claim 2, wherein the first carrier member further comprises a fluid passage arranged to provide fluid to the cylinder.

4. The continuously variable planetary of claim 3, further comprising a valve coupled to the piston, the valve comprising a valve orifice, the valve adapted to axially displace in unison with the piston to expose the valve orifice to the fluid passage.

5. The continuously variable planetary of claim 2, further comprising a ball-and-cam type axial force generator coupled to the idler and the second carrier member.

6. The continuously variable planetary of claim 2, further comprising a second axial positioning mechanism coupled to the idler and the second carrier member.

7. The continuously variable planetary of claim 6, wherein the second axial positioning mechanism further comprises an axial thrust bearing coupled to the second carrier member, a piston coupled to the axial thrust bearing, a cylinder coupled to the idler, the cylinder configured to surround the piston, the cylinder comprising a fluid passage 72 arranged on an outer periphery of the cylinder.
